(19) United States
(12) Patent Application Publication
(10) Pub. No.: US 2001/0054434 A1
(43) Pub. Date: Dec. 27, 2001

(54) HEIGHT-ADJUSTING MEDICAL CRUTCH

(76) Inventor: KYUNGIL CHO, KOYANG-CITY (KR)

Correspondence Address: MCGUIRE WOODS LLP, 1750 TYSONS BOULEVARD, SUITE 1800, MCLEAN, VA, 22102-3915, US

(21) Appl. No.: 09/390,665

(22) Filed: Sep. 7, 1999

(30) Foreign Application Priority Data
Sep. 11, 1998 (KR) 98-017329

(51) Int. Cl. A61H 3/02

(52) U.S. Cl. 135/68

(57) ABSTRACT

A height-adjusting medical crutch, whose conventional one is made to be fixed in a two-dot method, in which a screw bolt and a nut are used on the parts which confront a middle bottom frame 100 and a side frame 102 by using an aluminum tube, wherein its improvement comprise a fixed globe 6, wherein its center is penetrated so that a middle bottom frame 4 may go in and out, a side frame 8, a rivet 10, by which the fixed globe 6 is fixed on lower part of the side frame 8 and a middle bottom frame 4, which is moved through the inner side of the fixed globe 6, so that the height of the medical-adjusting medical crutch may be easily adjusted. And, in this invention, a tight coupler 12 having an arc form is formed continuously on the inner radial surface of said fixed globe 6 and said tight coupler 12 adheres to space between the middle bottom frame 4 and the side frame 8 and a side frame 8a is penetrated to be inserted into both sides of the inner radial surface of the fixed globe 6a and the side frame 8a is fixed on the upper edge and lower edge of the medical crutch.

### BACKGROUND OF THE INVENTION

1. Field of the Invention

This invention relates to a medical crutch, and more particularly to a height-adjusting medical crutch, whose conventional controllable one is made to fix, in a two-dot method, a middle bottom frame and a side frame, which a medical crutch comprise, by using a screw bolt and a nut, but wherein, in this invention, a fixed globe is installed on the lower part at the connected part of a side frame and a middle bottom frame, and the middle bottom frame is made to be moved up and down by adhering to the inner side of the fixed globe tightly, so that the height of the medical crutch is easily adjusted.

2. Discussion of Related Art

In conventional medical crutches as shown by FIG. 5 attached, side frames 102 which are made of aluminum tubes, which has light in weight and have a good operational ability, are formed between the light and left sides of a middle bottom frame 100 and are fixed in a two-dot method by using two screw bolts and nuts for the top and bottom positions where a middle bottom frame 100 and side frames are folded.

The conventional configuration, which is configured as the above, controls the length of a medical crutch in a way to move a middle bottom frame 100 up and down by removing two screw bolts and nuts when adjusting the height of a medical crutch, so that it is inconvenient for a patient to use it as this method is somewhat complex.

In order to solve the above inconvenience, recently the push-button type of medical crutch has been proposed as shown in FIG. 6. This method is that a rather small fixed tube 104 is fixed into the inner side of side frames 102 which are configured in the right and left side, so that at the time of using the medical crutch, the middle bottom frame 100 can be moved up and down in the inner space. This method has a problem in that the medical crutch is shaken and its stability is reduced when a patient uses it because, when the medical crutch is maximized in length, a intersected part is small since the length of a middle bottom frame 100 is moved up and down only in the inner side of a small fixed tube 104 at the time of controlling the length of a medical crutch.

Also, in case that while the middle bottom frame 100 is moved up and down in the inner space of the tube in order to adjust the length of a medical crutch, and in this regard the space between a tube and a tube becomes tight, the moving operation of a middle bottom frame 100 becomes difficult to move. In these results, in order to adjust the length of a middle bottom frame, it is necessary to insert the middle bottom frame 100 by maintaining appropriate space and moving it up and down. In this regard, because of this crack, the middle bottom frame 100 is shaken and its stability is reduced.

Also in the method of the up and down moving adjustment of a middle button frame 100 and of fixing it. there is another problem in a patient's safety according as there happen shortcomings in that a button part falls into a hall because of its weight at the time of using it since a middle bottom frame is fixed because the button part, which is installed on a middle button frame, protrudes into the hall which is punched on the fixed tube 106.

### SUMMARY OF THE INVENTION

Accordingly, in order to overcome such drawbacks in the conventional art, it is therefore an object of the present invention to provide a medical crutch, wherein a fixed globe is installed on a connecting part of a middle bottom frame and side frames, which allows the middle bottom frame to be moved up and down while the middle bottom frame is tightened solidly in the inner side of the fixed globe in order to adjust the height of a medical crutch easily.

It is another object to provide a medical crutch which can be used more safely by mounting a fixed globe in one-dot or two-dot method even for conventional bolt or push button type of medical crutch.

To achieve these and other advantages and in connection with the purpose of the present invention, as embodied and broadly described, there is provided a height-adjusting medical crutch, whose conventional one is made to be fixed in a two-dot method, in which a screw bolt and a nut are used on parts which confront a middle bottom frame 100 and a side frame 102 by using an aluminum tube, wherein its improvement comprises a fixed globe 6, wherein its center is penetrated so that a middle bottom frame 4 may go in and out, a side frame 8, a rivet 10, by which the fixed globe 6 is fixed on lower part of the side frame 8 and a middle bottom frame 4, which is moved through the inner side of the fixed globe 6, so that the height of said medical-adjusting medical crutch may be easily adjusted.

According to another aspect of the present invention, there is also provided a height-adjusting medical crutch, wherein a tight coupler 12 having an arc form is formed continuously on the inner radial surface of the fixed globe 6 and the tight coupler 12 adheres to space between the middle bottom frame 4 and the side frame 8.

According to still another aspect of the present invention, there is also provided a height-adjusting medical crutch, wherein a side frame 8a is penetrated to be inserted into both sides of the inner radial surface of the fixed globe 6a and the side frame 8a is fixed on the higher edge and lower edge of the medical crutch.

According to still another aspect of this invention, there is also provided a height-adjusting medical crutch, wherein a fixed globe, which is formed in a round style in the shape of inner radical surface according to the medical crutch having the form of a round style or angular style in this invention, is made to be fixed on the side frames in a way that the middle bottom frame can be moved up and down.

### BRIEF DESCRIPTION OF THE ATTACHED DRAWINGS

A more complete appreciation of the invention, and many of the attendant advantage thereof, will be readily apparent as the same becomes better understood by reference to the following detailed description when considered in connection with the accompanying drawings in which like reference symbols represent the same or similar components, wherein:

FIG. 1 is a perspective view according to an embodiment of this invention, FIG. 2 is a cross sectional view of this invention, FIG. 3 is a perspective view according to another embodiment of this invention, FIG. 4 is a perspective view according to still another embodiment of this invention, FIG. 5 is a perspective view of a screw bolt type of conventional medical crutch, FIG. 6 is a perspective view of button type of conventional medical crutch.

### DETAILED DESCRIPTION OF PREFERRED EMBODIMENT

From the following, the most desirable embodiment of this invention will be described in detail according to the attached drawings. First of all, the same reference number will be used to mean the same drawing elements regardless of different drawings.

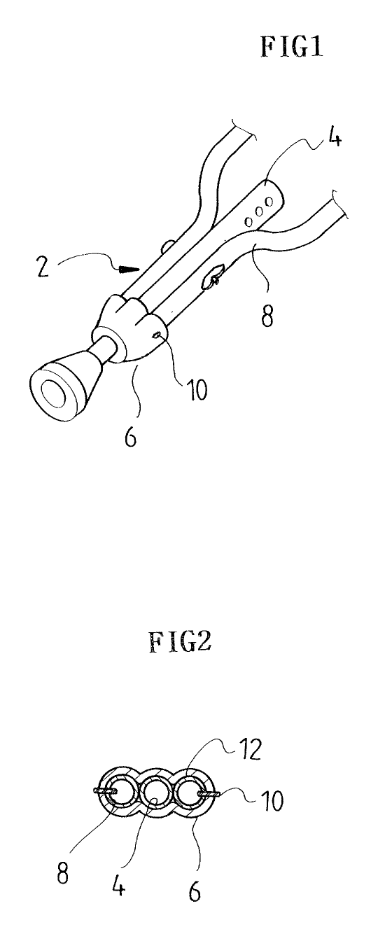

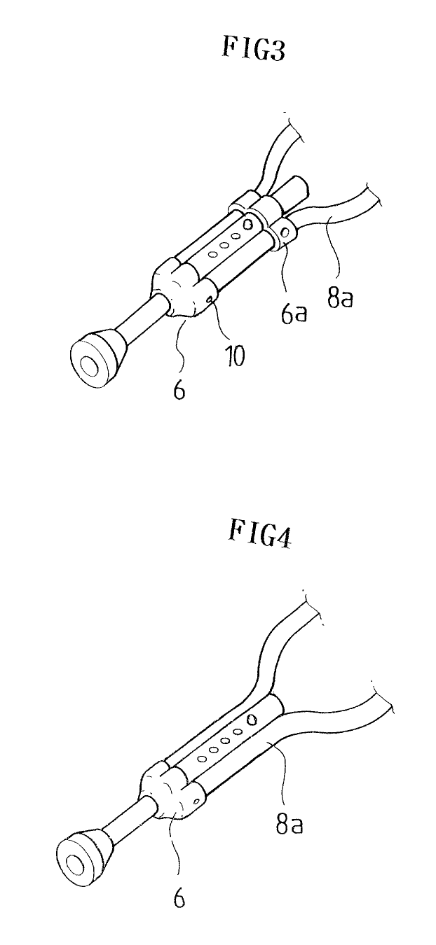

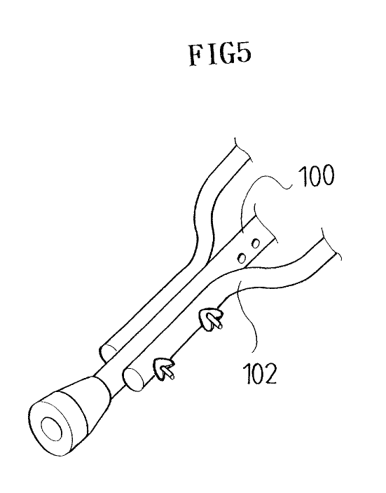

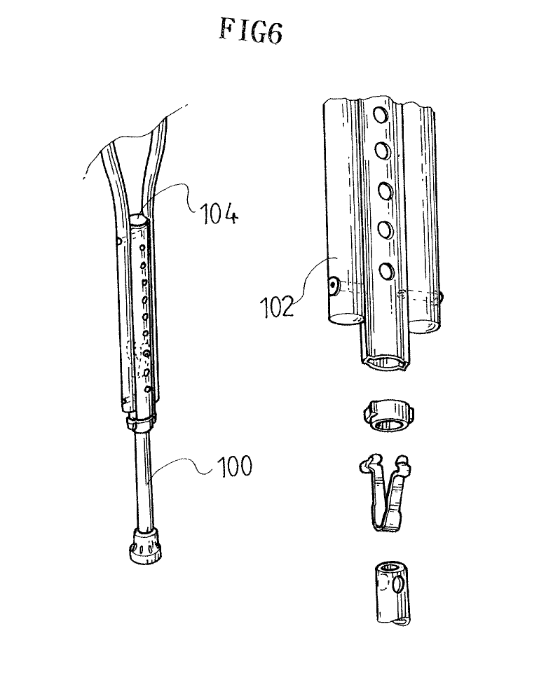

As shown in FIG. 1 through 4, in a conventional medical crutch, which is made to be fixed in a two-dot method, in which a screw bolt and a nut are used on parts which confront a middle bottom frame 100 and a side frame 102 by using an aluminum tube, the configuration of this invention is that a middle bottom frame 4 is fixed on the lower side of side frames 8 by a rivet 10 so that a middle bottom frame 4 may enter the center of the fixed globe 6, which is formed integrally in a figure which is continuous in an arc type or a angular type toward inner radial surface according to the figure of a middle bottom frame 4 and side frames 8 which forms a medical crutch 2

The above described inner radial surface is made to have an arc type of tight coupler 12 continuously. When an aluminum tube is used for the tight coupler 12, it is tighten in the space of the middle bottom frame 4 and side frames 8, so that the middle bottom frame is fixed solidly.

Also, the above fixed globe 6 should not have elasticity and is made integrally of the material which does not easily break, so it can fix the middle bottom frame 4 and side frames 8 solidly.

FIG. 3 and FIG. 4 are the other embodiments of this invention. If the side frames 8a pass through the lower part, inserted into the both sides of the inner radial surface of the fixed globe 6a and fixed by a rivet 10 on the higher and lower part of side frame 8a of the medical crutch 2a, wherein a well known conventional push button is mounted, a user can use the medical crutch safely even in the case the middle bottom frame 4 is extended longest at the time of using the push button type of medical crutch.

At this time, if the middle bottom frame 4 is made to be moved in the tube by making the middle bottom frame 4 extended and it is intersected to have constant space, the stability of a medical crutch can be maximized.

The effect of this invention configured as the above is that the operation of manufacturing a medical crutch is simple because an arc type of tight coupler 12 is formed integrally according to the figures of a middle bottom frame 4 and a side frame 8 which are made of the material which does not break easily, while the middle bottom frame 4 is inserted into its center to be able to be moved and the fixed globe 6 is formed integrally with them.

The fixed globe 6 is fixed on the side frame 8 solidly if the fixed globe 6, which is manufactured the same as the above, is inserted into the lower edge of the side frame 8, 8a, the lower edge of push type of medical crutch or conventional well-known two-dot bolt type of medical crutch, and is fixed by a rivet 10.

If the middle bottom frame 4 is inserted into the center of the fixed globe 6 after completing the fixed globe 6, the middle bottom frame 4 is placed in the inner side of the side frame 8 and V-type of space is made on the osculating plane. In this result, the middle bottom frame 4 and side frames 8 are tightened solidly because the tight coupler 12 which is formed in the inner side of the fixed globe 6 is tightened in the space.

At the state that the middle bottom frame is inserted as the above, the fixing operation, which fixes the middle bottom frame 4 on the side frame 8, is completed if a screw bolt and a nut is fixed on the higher part.

Accordingly, through the operation that tightens and loosens a screw bolt and a nut which are configured in conventional two-dot type, the middle bottom frame 4 can be fixed easily, not because of the operation that fixes the middle bottom frame 4, but because of the operation that tightens and loosens one locking bolt by moving the middle bottom frame 4 through the inner side of the fixed globe 6. In this results, not only is it possible to perform the fixing operation, but also the middle bottom frame 4 and side frames 8 can be fixed solidly since the tight coupler 12 is placed in the space between the interval when the middle bottom frame 4 and the side frame 8 is tightened.

Also, at the time that the conventional push button type of medical crutch is applied, if the fixed globe 6 is inserted into the higher part and lower part of the side frame 8a the same as above described medical crutch and is fixed by a rivet 10, the inner tight coupler of the fixed globe 6 is tightened on the middle bottom frame 4 and the side frame 8, so that the middle bottom frame 4 can be fixed solidly, and so that the stability of the medical crutch can be maximized without the moving of the medical crutch.

Also, if the fixed globe 6, 6a is fixed on the higher part and lower part of a medical crutch by using the fixed globe 6a, in which the both sides of inner radial surface penetrates, and the middle bottom frame 4 is extended, this invention is safer than the push button type of medical crutch because constant length is intersected.

Also, at the time of using a medical crutch, this invention is much safer than the conventional medical crutch when walking because the lower edge of the middle bottom frame 4 is tightened solidly in the inner side of the fixed globe 6.

As described the above, this invention has a good effect in that not only the fixing operation of a medical crutch is easy, but also the height of a medical crutch is quickly and easily adjusted because a fixed globe, which forms inner radial surface equal to the figures of a middle bottom frame and a side frame, is installed to be fixed on a side frame.

Although the preferred embodiments of the present invention have been disclosed for illustrative purpose, those skilled in the art will appreciate that various modifications, additions and substitutions are possible, without departing from the scope and spirit of the invention as disclosed in the accompanying claims.

What is claimed is:

1. A height-adjusting medical crutch, whose conventional one is made to be fixed in a two-dot method, in which a screw bolt and a nut are used on parts which confront a middle bottom frame 100 and a side frame 102 by using an aluminum tube, wherein its improvement comprising:
a fixed globe 6, wherein its center is penetrated so that a middle bottom frame 4 may go in and out;
a side frame 8;
a rivet 10, by which said fixed globe 6 is fixed on lower part of said side frame 8;
and a middle bottom frame 4, which is moved through inner side of said fixed globe 6, so that the height of said medical-adjusting medical crutch may be easily adjusted.

2. A height-adjusting medical crutch as claimed in claim 1, wherein a tight coupler 12 having an arc form is formed continuously on the inner radial surface of said fixed globe 6 and said tight coupler 12 adheres to space between said middle bottom frame 4 and said side frame 8.

3. A height-adjusting medical crutch as claimed in claim 1 or claim 2, wherein a side frame 8a is penetrated to be inserted into both sides of the inner radial surface of said fixed globe 6a and said side frame 8a is fixed on the higher edge and lower edge of said medical crutch.
